(19) United States
(12) Patent Application Publication
(10) Pub. No.: US 2016/0158851 A1
(43) Pub. Date: Jun. 9, 2016

(54) Iron-Cutting Drill

(71) Applicant: Shajeng Hardware Co., Ltd., Taichung City (TW)

(72) Inventor: Jen Tsung Liao, Taichung City (TW)

(21) Appl. No.: 14/564,133

(22) Filed: Dec. 9, 2014

(51) Int. Cl. B23B 51/04

(52) U.S. Cl. CPC B23B 51/04; B23B 2222/44; B23B 2226/75; B23B 2251/046; B23B 2251/408; B23B 2251/428; B23B 2251/46

(57) ABSTRACT

An iron-cutting drill includes a shank and two threaded section. The first threaded section extends from an end of the shank and includes a helical groove made of a helix angle smaller than 45°. The second threaded section extends from the first threaded section and includes several helical grooves, a cavity, several apertures and several blades. The helical grooves of the second section are in communication with the helical groove of the first threaded section. The helical grooves of the second section are made with a helix angle larger than 45°. The cavity is axially made in a free end of the second threaded section. The apertures are in communication with the cavity. The blades are formed around the cavity.

### BACKGROUND OF INVENTION

1. Field of Invention

The present invention relates to an iron-cutting drill and, more particularly, to an iron-cutting drill for signaling a user after accumulating a limited amount of concrete debris.

2. Related Prior Art

Referring to FIG. 4, a conventional concrete-cutting drill is used to drill a concrete construction 20 reinforced by an iron bar 21. The concrete-cutting drill is not useful for cutting the iron bar 21. After reaching the iron bar 21, the concrete-cutting drill is pulled out of the concrete construction 20 and replaced with a conventional iron-cutting drill. The iron-cutting drill is used to cut the iron bar 21. The iron-cutting drill is not good at drilling the concrete construction. After cutting the iron bar 21, the iron-cutting drill is pulled out of the concrete construction 20 and replaced with the concrete-cutting drill. The iron-cutting drill would suffer excessive wearing should it be used to drill the concrete construction 20. It is however difficult to know when the cutting of the iron bar 21 is finished. A user has to pull the iron-cutting drill out of the concrete construction 20 and check the iron-cutting drill several times before he or she knows whether the cutting of the iron bar 21 is finished.

The present invention is therefore intended to obviate or at least alleviate the problems encountered in prior art.

### SUMMARY OF INVENTION

It is the primary objective of the present invention to provide an iron-cutting drill for signaling a user after accumulating a limited amount of concrete debris.

To achieve the foregoing objective, the iron-cutting drill includes a shank and two threaded section. The first threaded section extends from an end of the shank and includes a helical groove made of a helix angle smaller than 45°. The second threaded section extends from the first threaded section and includes several helical grooves, a cavity, several apertures and several blades. The helical grooves of the second section are in communication with the helical groove of the first threaded section. The helical grooves of the second section are made with a helix angle larger than 45°. The cavity is axially made in a free end of the second threaded section. The apertures are in communication with the cavity. The blades are formed around the cavity.

Other objectives, advantages and features of the present invention will be apparent from the following description referring to the attached drawings.

### BRIEF DESCRIPTION OF DRAWINGS

The present invention will be described via detailed illustration of the preferred embodiment versus the prior art referring to the drawings wherein:

FIG. 1 is a perspective view of an iron-cutting drill according to the preferred embodiment of the present invention;

FIG. 2 is a cross-sectional view of a reinforced concrete construction drilled with the iron-cutting drill shown in FIG. 1;

FIG. 3 is a cut-away view of the iron-cutting drill shown in FIG. 1; and

FIG. 4 is a cross-sectional view of a reinforced concrete construction drilled with a conventional concrete-cutting drill.

### DETAILED DESCRIPTION OF PREFERRED EMBODIMENT

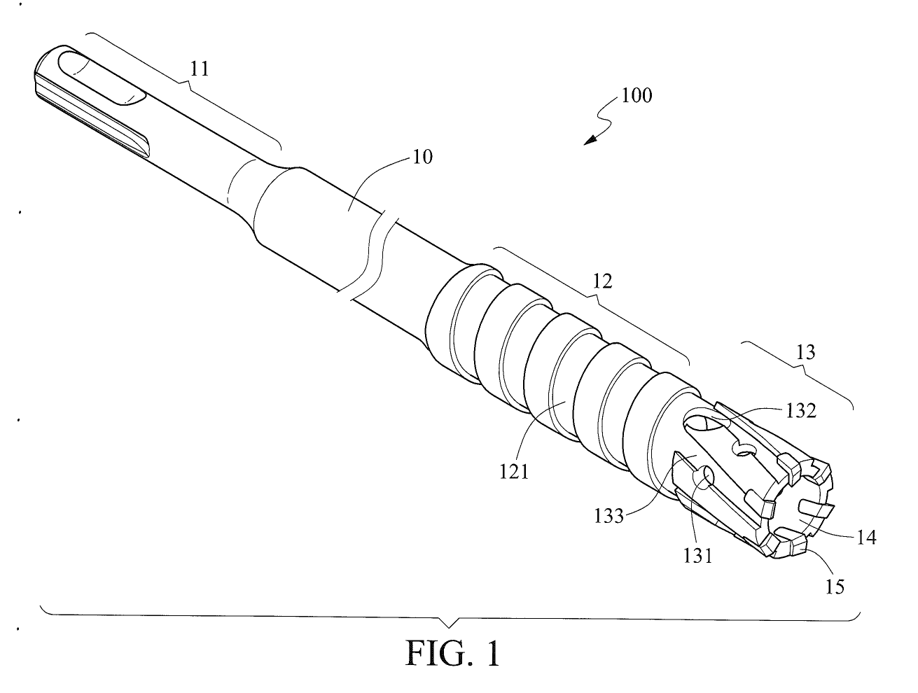

Referring to FIG. 1, an iron-cutting drill 100 includes a shank 10, an insert 11 axially extending from an end of the shank 10, a first threaded section 12 axially extending from another end of the shank 10, and a second threaded section 13 axially extending from the first threaded section 12 according to the preferred embodiment of the present invention. The shank 10 is made with a smooth periphery.

The insert 11 is made with a diameter smaller than that of the shank 10. The insert 11 includes a slot (not numbered). The insert 11 can be inserted in an electrical tool (not shown).

The first threaded section 12 includes a spiral groove 121 defined by a single thread (not numbered) formed thereon. The spiral groove 121 is made of a helix angle that is smaller than 45°. This helix angle of the spiral groove 121 is intended to facilitate transportation and disposition of concrete debris.

The second threaded section 13 includes several spiral grooves 133 defined by several threads (not numbered) formed thereon. The spiral grooves 133 are made of a helix angle that is larger than 45°. This helix angle of the spiral grooves 133 is intended to facilitate transportation and disposition of iron debris. This helix angle of the spiral grooves 133 is not suitable for transportation and disposition of concrete debris.

The second threaded section 13 further includes several apertures 131 made in the periphery, and an opening 132 made in the periphery. Each aperture 131 is made with a center located at an edge of a corresponding spiral groove 133. That is, the center of each aperture 131 is located at a borderline between the corresponding spiral groove 133 and a corresponding thread of the second threaded section 13.

A cavity 14 is axially made in the tip of the second threaded section 13 so that the second threaded section 13 is shaped like a crown. The cavity 14 is in communication with the apertures 131 and the opening 132.

Several blades 15 are formed at the tip of the second threaded section 13. Each blade 15 is located at an end of a corresponding helical groove 133.

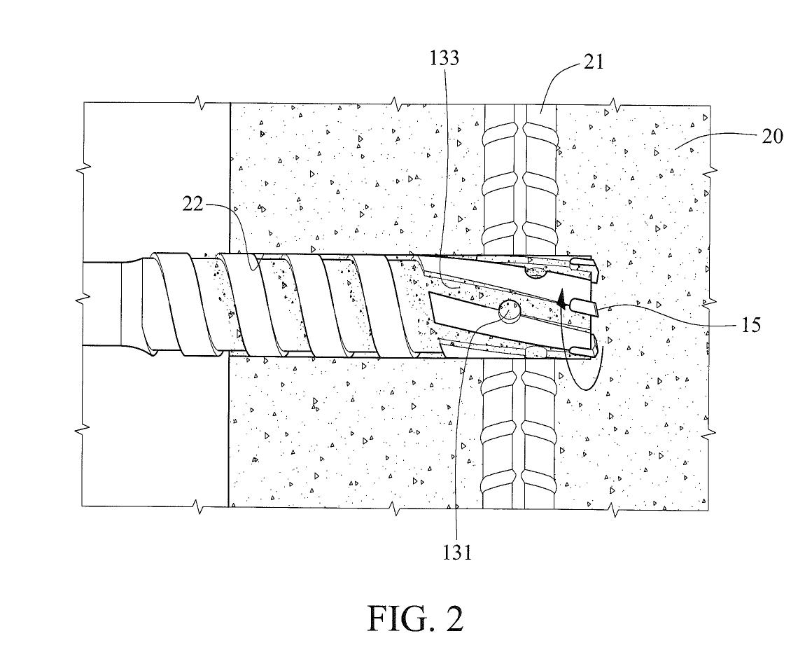

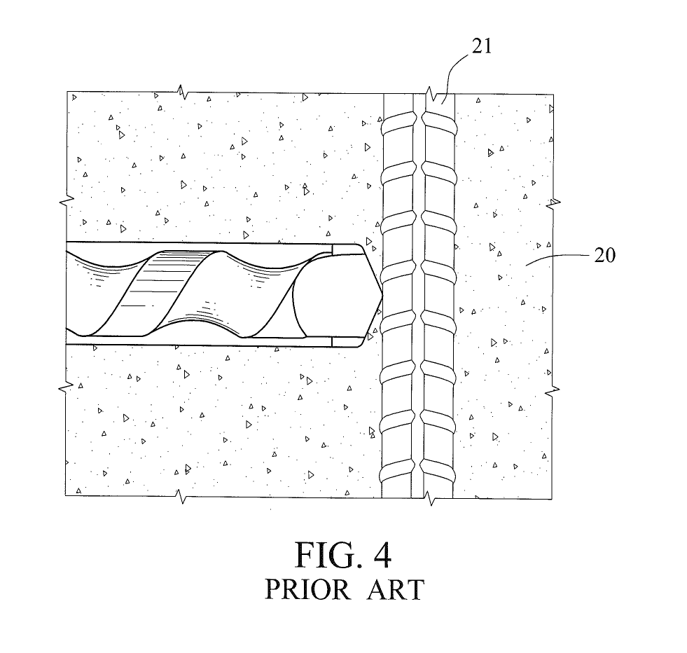

In use, a concrete-cutting drill (not numbered) is used to drill a concrete construction 20 reinforced by an iron bar 21 as described in Related Prior Art referring to FIG. 4. Thus, a bore 22 (FIG. 2) is made in the concrete construction 20. After reaching the iron bar 21, the concrete-cutting drill is pulled out of the concrete construction 20.

Referring to FIG. 2, the iron-cutting drill 100 is inserted in the bore 22. The spiral groove 121, with the helix angle being smaller than 45°, rapidly transports the concrete debris out of the bore 22.

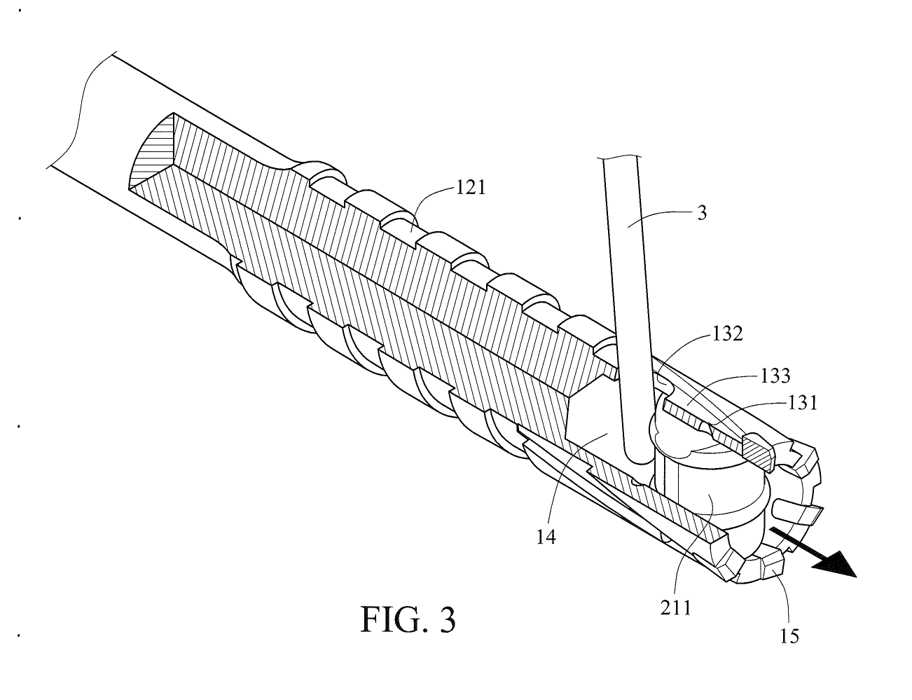

Then, the iron-cutting drill 100 is used to cut the iron bar 21. The cutting of the iron bar 21 produces iron debris. Some of the iron debris enters the helical grooves 133. The other iron debris enters the cavity 14 and then travels into the helical grooves 133 from the cavity 14 via the apertures 131. The helical grooves 133, with the helix angle being larger than 45°, rapidly transports the iron debris into the helical groove 121. Then, the iron debris is transported out of the bore 22 by the helical groove 121. On the moment when the cutting of the iron bar 21 is finished, a fragment 211 is cut from the iron bar 21 and the fragment of the iron bar 21 is left in the cavity 14 referring to FIG. 3.

Referring to FIG. 2, the iron-cutting drill 100 reaches the concrete and cuts some of the concrete, thus producing more concrete debris. The concrete debris cannot effectively be transported in and along the helical grooves 133. Hence, the concrete debris is accumulated in the helical grooves 133. Soon, the helical grooves 133 are full of the concrete debris, and this causes the iron-cutting drill 100 to spin without advancing in the concrete construction 20. This lag signals a user that the cutting of the iron bar 21 is finished so that the user can pull the iron-cutting drill out of the concrete construction 20, and replace the iron-cutting drill 100 with the concrete-cutting drill.

Referring to FIG. 3, a tool 3 in the form of a rod is inserted in the cavity 14 through the opening 132. The tool 3 is maneuvered to push the segment 211 out of the cavity 14.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An iron-cutting drill including:
a shank 10;
a first threaded section 12 extending from an end of the shank 10 and including a helical groove 121 made of a helix angle smaller than 45°, and
a second threaded section 13 extending from the first threaded section 12 and including several helical grooves 133 made with a helix angle larger than 45° and in communication with the helical groove 121 of the first threaded section 12, a cavity 14 axially made in a free end of the second threaded section 13, several apertures 131 in communication with the cavity 14, and several blades 15 formed around the cavity 14.

2. The iron-cutting drill according to claim 1, wherein the second threaded section 13 includes an opening 132 in communication with the cavity 14 so that a tool can be inserted into the cavity 14 through the opening 132.

3. The iron-cutting drill according to claim 1, further including an insert 11 axially extending from another end of the shank 10.

4. The iron-cutting drill according to claim 1, wherein each of the blades 15 is located at an open end of a corresponding one of the helical grooves 133 of the second threaded section 13.

5. The iron-cutting drill according to claim 1, wherein each of the apertures 131 includes a center located at an edge of a corresponding one of the helical grooves 133 of the second threaded section 13.
